(19) United States
(12) Patent Application Publication
(10) Pub. No.: US 2026/0194284 A1
(43) Pub. Date: Jul. 9, 2026

(54) PORTABLE REFRIGERATOR

(71) Applicant: Anker Innovations Technology Co., Ltd., CHANGSHA (CN)

(72) Inventors: Jinling PENG, SHENZHEN (CN); Qizhen OU, SHENZHEN (CN)

(21) Appl. No.: 19/439,205

(22) Filed: Jan. 2, 2026

(30) Foreign Application Priority Data
Jan. 8, 2025 (CN) 202520043839.7
Jan. 8, 2025 (CN) 202520044001.X

(51) Int. Cl. F25D 11/00; F25D 23/00; F25D 23/06

(52) U.S. Cl. CPC F25D 11/003; F25D 23/006; F25D 23/066

(57) ABSTRACT

The present application relates to a portable refrigerator. The portable refrigerator includes a refrigerator housing. An interior of the refrigerator housing is defined with a refrigeration area and an assembly installation area disposed side by side and adjacent to each other. A battery assembly and a refrigeration assembly are disposed in the assembly installation area, the refrigeration assembly is disposed at a bottom of a side of the refrigerator housing, and the battery assembly is disposed above the refrigeration assembly. The refrigeration area is defined by inner liner walls configured to accommodate and refrigerate items, and a side of the inner liner walls proximate to the assembly installation area has no overlap in a vertical direction with sides of the refrigeration assembly and the battery assembly proximate to the refrigeration area.

### CROSS REFERENCE TO RELATED APPLICATIONS

The present disclosure claims priorities to Chinese Patent Application No. 202520043839.7, filed on January 08, 2025, and Chinese Patent Application No. 202520044001.X, filed on January 08, 2025, the entire contents of these applications are incorporated herein by reference.

### TECHNICAL FIELD

The present disclosure relates to the technical field of outdoor refrigerator devices, and in particular to a portable refrigerator.

### BACKGROUND

Many existing outdoor refrigerators have unreasonable overall space design and component layout, resulting in electronic components occupying refrigeration space inside the refrigerator. This makes the refrigerator large in size and affects the space utilization rate of the refrigerator.

Therefore, how to improve the space utilization rate of the refrigerator is a technical problem that needs to be solved by those skilled in the art at present.

### SUMMARY

A portable refrigerator may include a refrigerator housing. An interior of the refrigerator housing may be defined with a refrigeration area and a assembly installation area disposed side by side and adjacent to each other. A battery assembly and a refrigeration assembly may be disposed in the assembly installation area, the refrigeration assembly may be disposed at a bottom of a side of the refrigerator housing, and the battery assembly may be disposed above the refrigeration assembly. The refrigeration area may be defined by inner liner walls configured to accommodate and refrigerate items, and a side of the inner liner walls proximate to the assembly installation area may have no overlap in a vertical direction with sides of the refrigeration assembly and the battery assembly proximate to the refrigeration area.

### BRIEF DESCRIPTION OF THE DRAWINGS

Accompanying drawings may be incorporated into the description and constitute a part of the description, showing embodiments consistent with the present disclosure, and in conjunction with the description to explain the principles of the present disclosure. In order to more clearly illustrate the technical solutions in the embodiments of the present disclosure or the technical solutions in the related art, the accompanying drawings needed to be used in the description of the embodiments or the related art may be briefly introduced below. Obviously, for those of ordinary skilled in the art, other drawings may be obtained based on the accompanying drawings without creative work. One or more embodiments may be exemplarily illustrated by figures in the corresponding accompanying drawings. The exemplary illustrations may not constitute a limitation on the embodiments. Elements with the same reference number in the accompanying drawings represent similar elements. Unless otherwise stated, the figures in the accompanying drawings may not constitute a scale limitation.

FIG. 1 is a schematic overall structure view of a portable refrigerator according to some embodiments of the present disclosure.

FIG. 2 is a schematic structure view of an accommodating groove according to some embodiments of the present disclosure.

FIG. 3 is a schematic structure view of a battery cover according to some embodiments of the present disclosure.

FIG. 4 is a schematic structure view of a refrigeration assembly according to some embodiments of the present disclosure.

FIG. 5 is a schematic structure view of a radiator according to some embodiments of the present disclosure.

FIG. 6 is another schematic overall structure view of a portable refrigerator according to some embodiments of the present disclosure.

FIG. 7 is a schematic structure view of a connecting strip according to some embodiments of the present disclosure.

FIG. 8 is a schematic rear view of a side plate according to some embodiments of the present disclosure.

FIG. 9 is a schematic front view of a side plate according to some embodiments of the present disclosure.

FIG. 10 is a schematic structure view of a battery pack according to some embodiments of the present disclosure.

FIG. 11 is a schematic structure view of a storage compartment according to some embodiments of the present disclosure.

FIG. 12 is a schematic structure view of a handle hole and a hook according to some embodiments of the present disclosure.

### DETAILED DESCRIPTION

In order to make the purposes, technical solutions, and advantages of the embodiments of the present disclosure clearer, the technical solutions in the embodiments of the present disclosure will be described clearly and completely below in conjunction with the accompanying drawings in the embodiments of the present disclosure. Obviously, the described embodiments may only be a part of the embodiments of the present disclosure, rather than all the embodiments. Based on the embodiments of the present disclosure, all other embodiments obtained by those of ordinary skill in the art without creative work shall fall within the protection scope of the present disclosure.

The following disclosure may provide a plurality of different embodiments or examples for implementing different structures of the present disclosure. In order to simplify the disclosure of the present disclosure, components and arrangements of examples may be described below. Of course, the components and the arrangements may only be examples and may not be intended to limit the present disclosure. In addition, the present disclosure may repeat reference numbers and/or letters in different examples. Such repetition may be for the purpose of simplification and clarity, and the reference numbers and/or letters may not indicate the relationship between various embodiments and/or arrangements described. In addition, the present disclosure may provide examples of various processes and materials, but those of ordinary skill in the art may realize the applicability of other processes and/or the use of other materials.

For ease of description, spatially relative terms such as "inside", "outside", "inner side", "outer side", "below", "under", "above", "over", "front", "rear", etc. may be used in the description to describe a relative positional relationship or movement of one element or feature relative to another element or feature as shown in the drawings. These spatially relative terms may be intended to include different orientations of a device in use or operation in addition to orientations depicted in the drawings. When the device in the drawings undergoes a position flip, posture change, or movement state change, these directional indications will change accordingly. For example, an element described as "below other elements or features" or "under other elements or features" may be oriented as "above other elements or features" or "over other elements or features". Therefore, the exemplary term "below" may include both above and below orientations. The device may be otherwise oriented (e.g., rotated by 90 degrees or in other directions), and the spatially relative terms used herein may be interpreted accordingly.

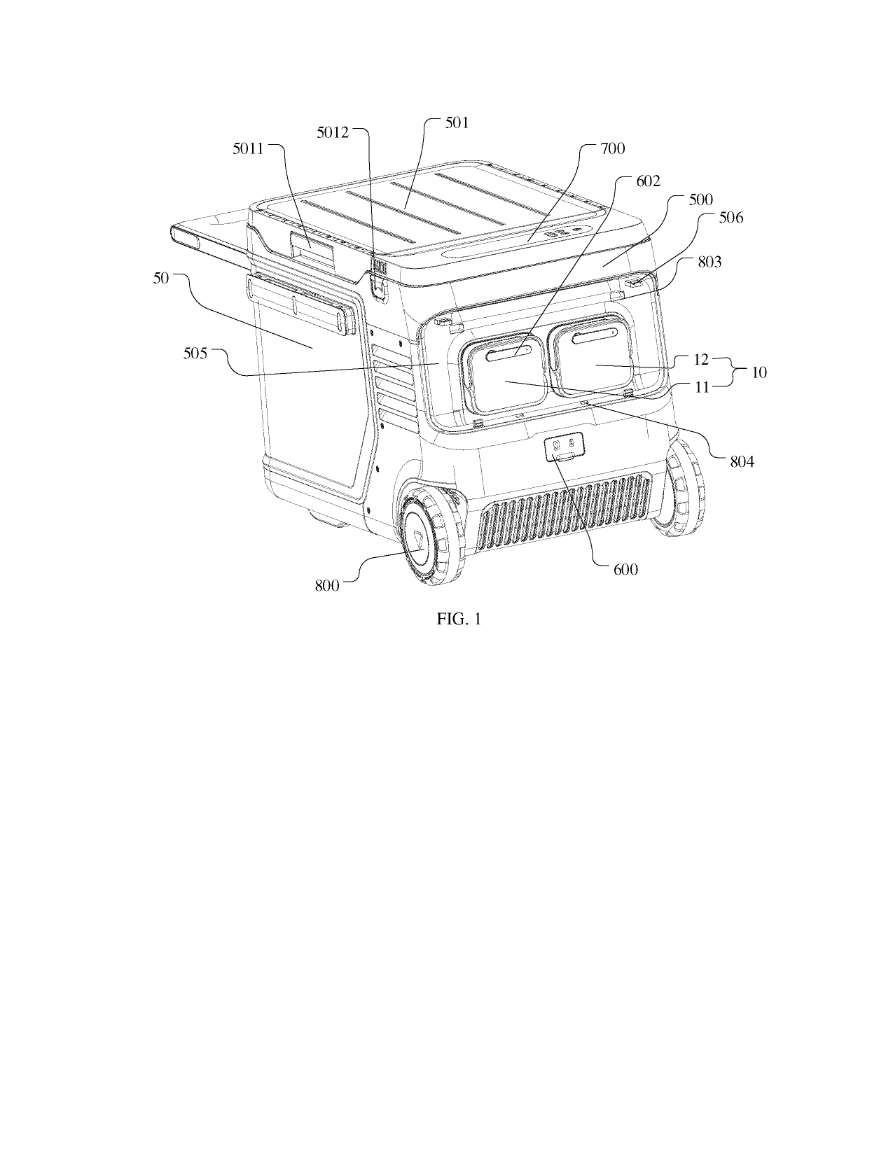

As shown in FIG. 1 and FIG. 4, embodiments of the present disclosure may provide a portable refrigerator including a refrigerator housing 50. A refrigeration area and an assembly installation area disposed side by side and adjacently may be defined inside the refrigerator housing 50. The assembly installation area may be provided with a battery assembly 10 and a refrigeration assembly. The refrigeration assembly may be disposed at a bottom of a side of the refrigerator housing 50. The battery assembly 10 may be disposed above the refrigeration assembly. The refrigeration area may be defined by inner liner walls configured to accommodate and refrigerate items. A side of the inner liner walls proximate to the assembly installation area may have no overlap in a vertical direction with sides of the refrigeration assembly and the battery assembly 10 proximate to the refrigeration area.

In some embodiments, both the refrigeration area and the assembly installation area may be square as a whole, so as to divide an interior of the refrigerator into two independent square structures, realizing the maximization of the refrigeration area under conditions of meeting power supply and refrigeration.

The portable refrigerator provided by the embodiments of the present disclosure may integrate the battery assembly 10 and the refrigeration assembly on the same side of the refrigerator. The battery assembly 10 and the refrigeration assembly may be disposed vertically (one above the other), enabling an area below the battery assembly 10 to accommodate the refrigeration assembly, making full use of a vertical space inside the refrigerator housing 50 and thus realizing an integrated design of the assembly installation area. Moreover, since the side of the inner liner walls proximate to the assembly installation area has no overlap in the vertical direction with the sides of the refrigeration assembly and the battery assembly 10 proximate to the refrigeration area, compared with an internal design of a refrigerator in the related art, the present disclosure may not only realize the integration of electrical assemblies of the portable refrigerator but also increase an usable space of the refrigeration area, thereby realizing the maximization of the refrigeration area of the refrigerator and improving the space utilization rate of the refrigerator.

In some embodiments, the refrigeration assembly may include a compressor 200, a radiator 201, and a condenser 202. The compressor 200, the radiator 201, and the condenser 202 may be disposed side by side below the battery assembly 10. The compressor 200, the radiator 201, and the condenser 202 may be reasonably disposed in the assembly installation area, so that the side of the inner liner walls of the refrigeration area proximate to the assembly installation area may form a vertical surface, so as to achieve no overlap in the vertical direction and realize the maximization of the refrigeration area of the refrigerator. The compressor 200, the radiator 201, and the condenser 202 may be disposed side by side below the battery assembly 10, so that the battery assembly 10 may be disposed above the compressor 200, the radiator 201, and the condenser 202, and the battery assembly 10, the compressor 200, the radiator 201, and the condenser 202 may all be located on the same side of the portable refrigerator, thereby optimizing an internal space layout of the portable refrigerator.

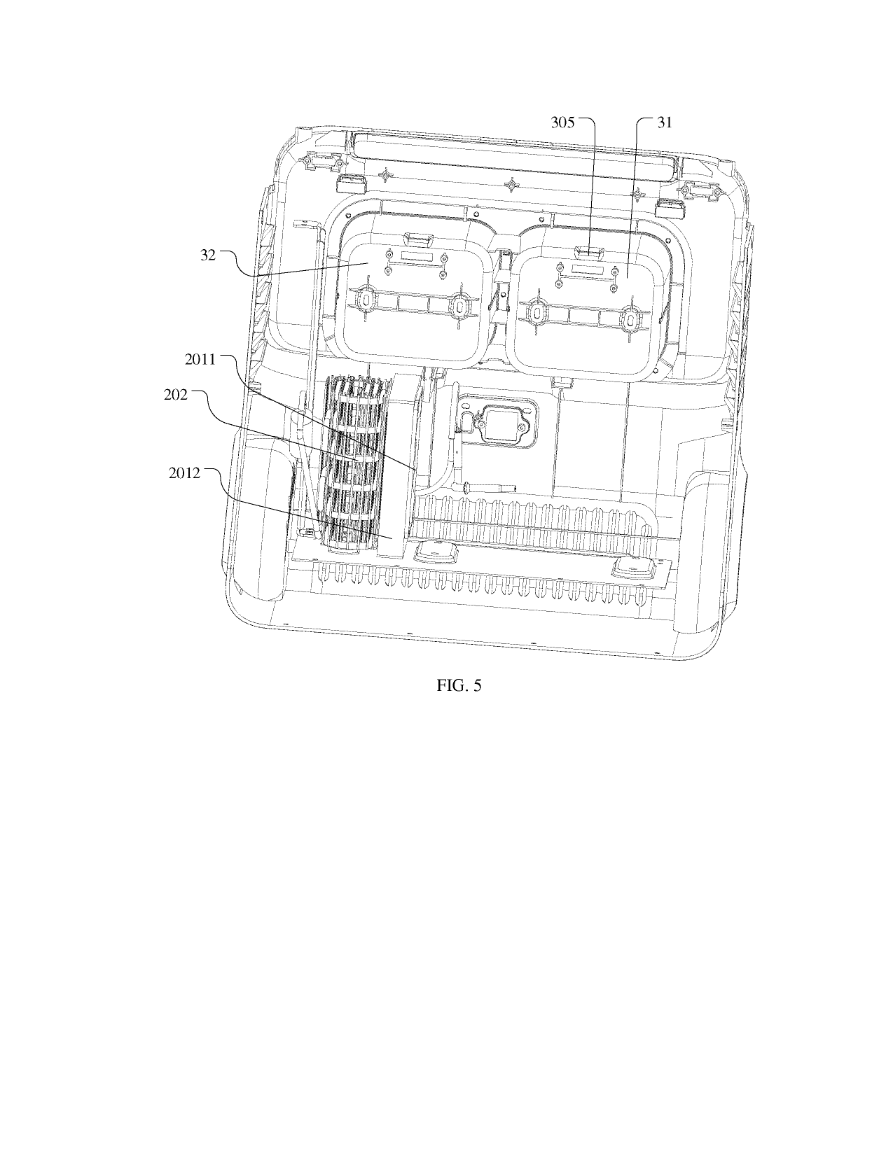

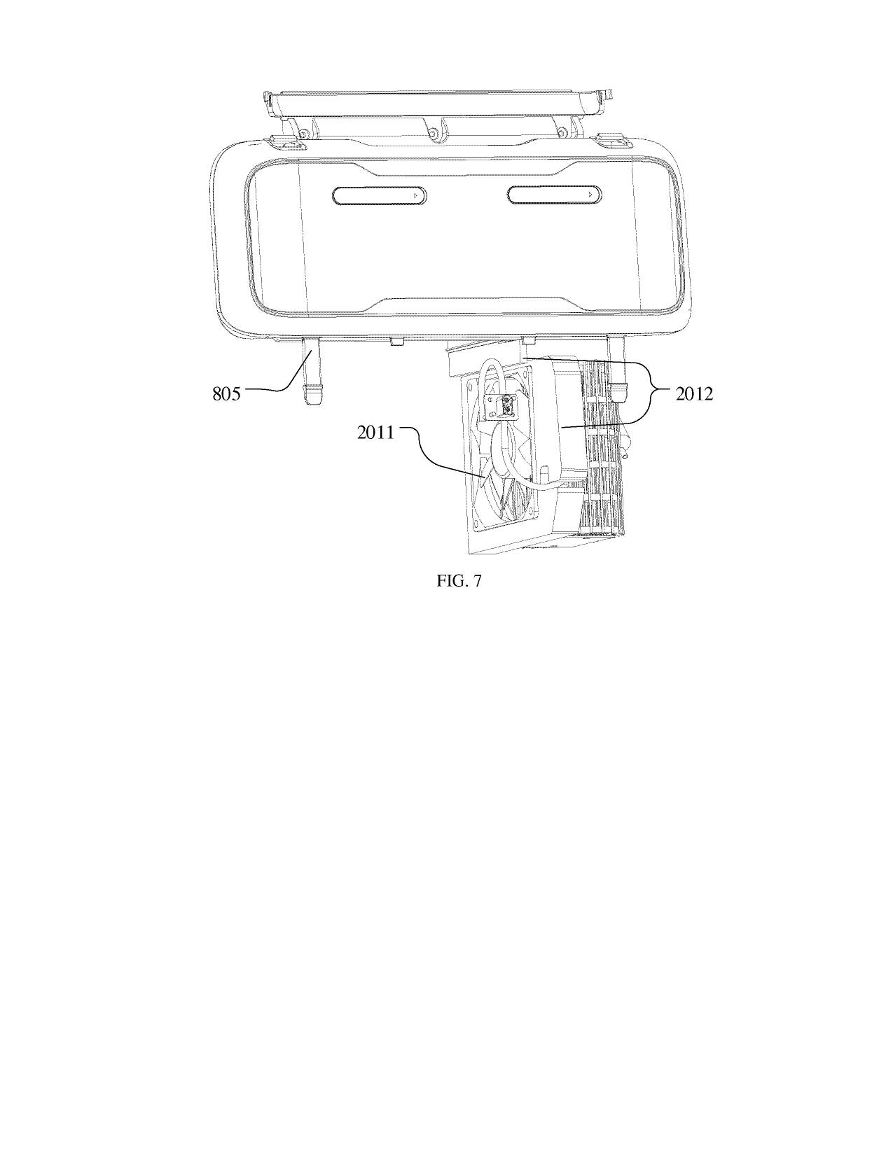

In some embodiments, as shown in FIG. 5 and FIG. 7, the radiator 201 may include a fan 2011 and a blocking member 2012. The compressor 200, the fan 2011, and the condenser 202 may be disposed side by side inside the refrigerator housing 50 and define a heat dissipation air duct. The blocking member 2012 may be connected to both a shell of the fan 2011 and an inner housing wall of the refrigerator housing that defines the heat dissipation air duct, thereby forming a single-channel air duct between the compressor 200 and the condenser 202. That is, the wind generated by the fan 2011 may only blow from an end where the condenser 202 is located to an end where the compressor 200 is located through gaps between fan blades of the fan 2011, thereby achieving the purpose of rapid heat dissipation.

In some embodiments, the blocking member 2012 may be made of EVA material (ethylene-vinyl acetate copolymer). The blocking member 2012 may be connected to both the shell of the fan 2011 and the inner housing wall of the refrigerator housing 50 that defines the heat dissipation air duct to form an EVA isolation wall. In this way, the airflow may flow unidirectionally within the heat dissipation air duct, forming the single-channel air duct.

During use, the fan 2011 may be disposed between the high-temperature compressor 200 and the condenser 202. The fan 2011 may generate the airflow, and the airflow may flow quickly from a side of the EVA isolation wall to the other side, forming a single-channel heat dissipation air duct to quickly reduce the temperature of the compressor 200, dissipate heat from the compressor 200 and the condenser 202, and improve the refrigeration capacity of the portable refrigerator.

Such an arrangement may integrate the compressor 200, the condenser 202, the fan 2011, and the blocking member 2012 inside the refrigerator housing 50, improving the heat dissipation efficiency and stability of the portable refrigerator while saving the structural space of the portable refrigerator.

Further, a filter screen may be provided on an air intake side of the fan 2011 to prevent dust and debris from contaminating the compressor 200 or the condenser 202.

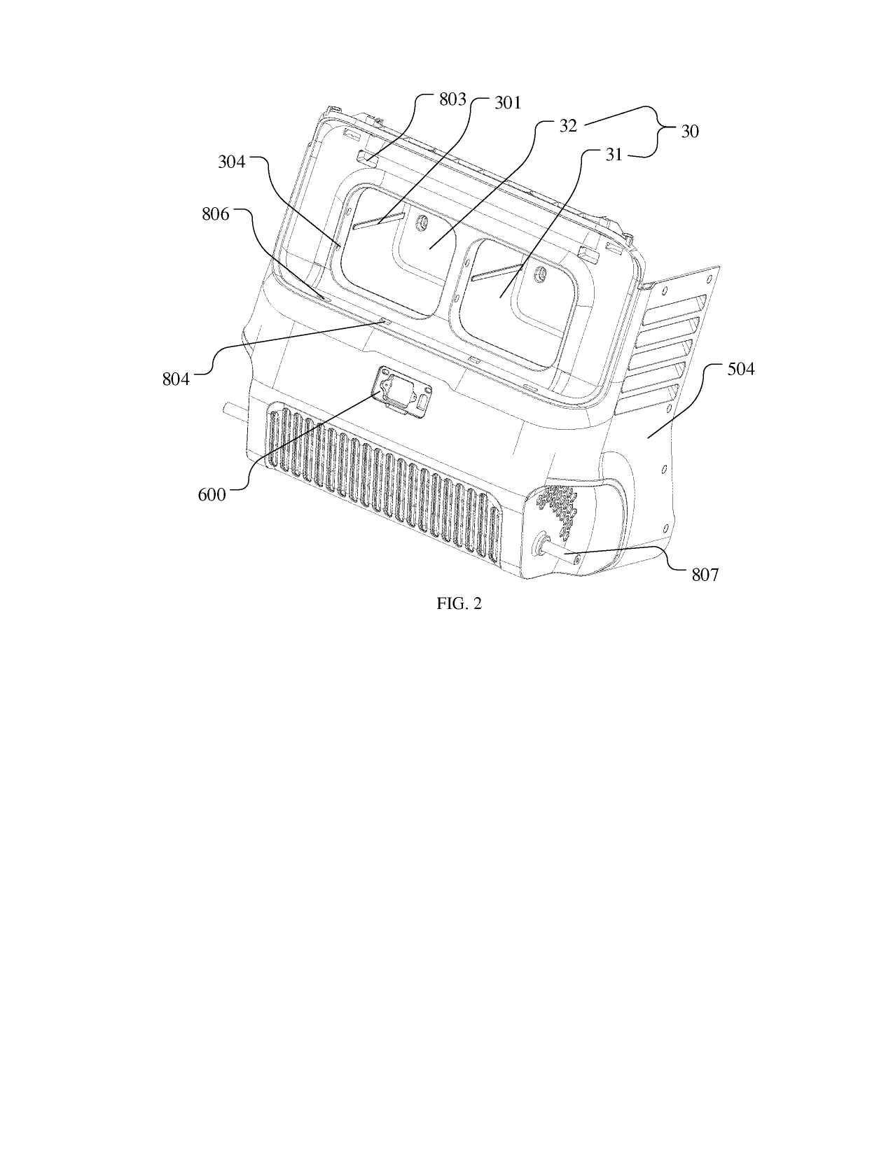

As shown in FIG. 2, the refrigerator housing 50 may include at least one accommodating groove 30. The battery assembly 10 may include at least one battery pack. The at least one accommodating groove 30 may be configured to accommodate the at least one battery pack. A first opening of the accommodating groove 30 may be accessible from an exterior of the refrigerator housing 50. A side wall of the battery pack and a groove wall of the accommodating groove 30 may be cooperatively configured to establish a detachable connection.

It should be noted that the at least one accommodating groove 30 may be defined above the refrigeration assembly. The accommodating groove 30 may be inclined at a certain angle relative to the vertical direction or a horizontal direction, so as to facilitate insertion of the battery pack and achieve a certain degree of limiting of the battery pack.

In some embodiments, the present disclosure may arrange a depth direction of the accommodating groove 30 to be parallel to the horizontal direction, or arrange the depth direction of the accommodating groove 30 to be parallel to the vertical direction, so that a total volume of the battery pack may be maximized. In some embodiments, a shape of the battery pack may match a shape of the accommodating groove 30. When the battery pack is disposed inside the accommodating groove 30, the battery pack may closely be matched with the accommodating groove 30.

During use, the battery pack may enter through the first opening of the accommodating groove 30, slide into the accommodating groove 30 along the depth direction of the accommodating groove 30, and fit closely with the accommodating groove 30, thereby achieving installation of the battery pack. At least one accommodating groove 30 may be provided to increase the battery capacity of the portable refrigerator and meet the user's demand for long-lasting battery life of the portable refrigerator.

Further, in order to simplify a process of replacing the battery pack, a quick-lock mechanism or a magnetic attraction device may be provided at the first opening of the accommodating groove 30, allowing the user to install and remove the battery pack more conveniently and efficiently.

The side wall of the battery pack and the groove wall of the accommodating groove 30 may be cooperatively configured to establish the detachable connection, realizing quick assembly and disassembly of the battery pack. The design of the accommodating groove 30 may prevent the battery pack from shaking randomly inside the portable refrigerator, ensuring the overall stability of the portable refrigerator.

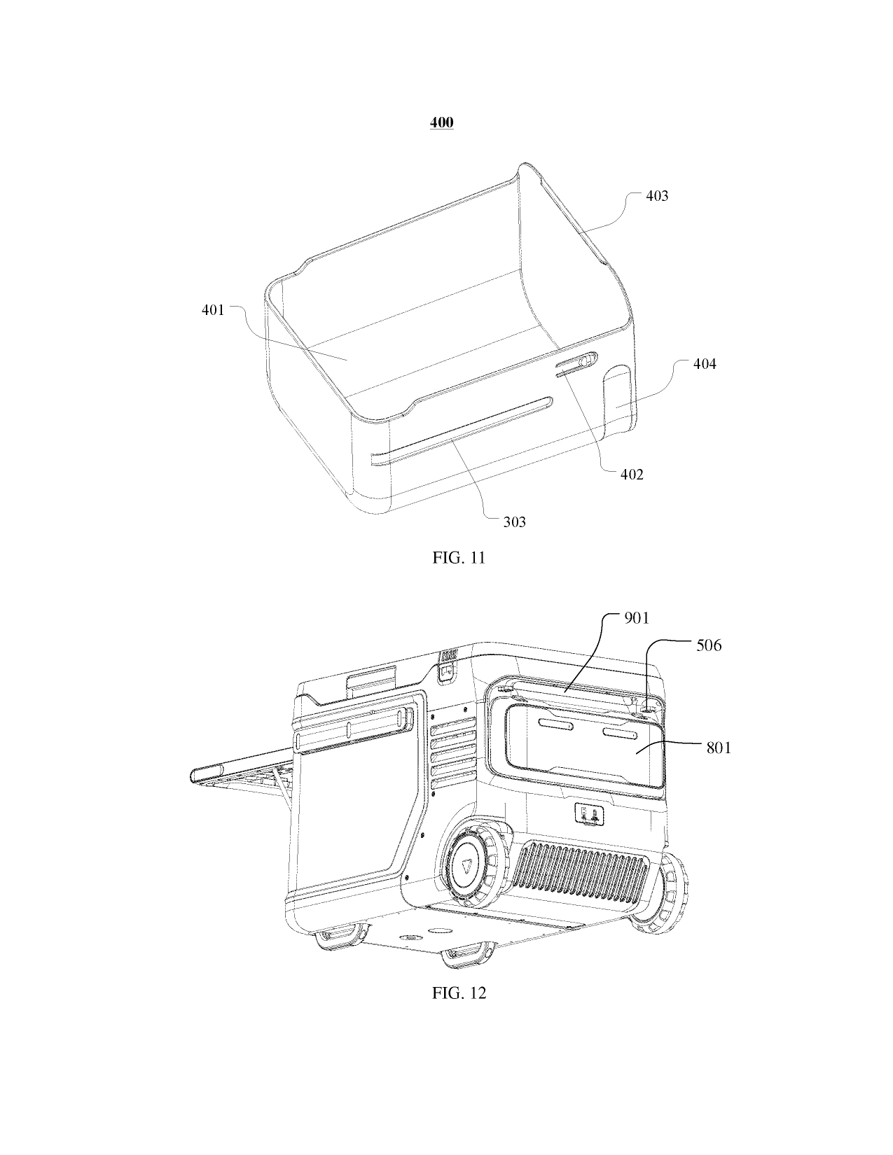

In some embodiments, the at least one accommodating groove 30 may include a first accommodating groove 31 and a second accommodating groove 32 that are disposed side by side and spaced apart from each other. As shown in FIG. 11, the portable refrigerator may further include a storage compartment 400. The storage compartment 400 may include a compartment body defined by five walls with a second opening 401 at the top. The first accommodating groove 31 may be configured to alternatively accommodate the battery pack or the storage compartment 400. The second accommodating groove 32 may be configured to alternatively accommodate the storage compartment 400 or the battery pack. A side wall of the storage compartment 400 and the groove walls of the first accommodating groove 31 and/or the second accommodating groove 32 may be cooperatively configured to establish a detachable connection. The side wall of the battery pack and the groove walls of the first accommodating groove 31 and/or the second accommodating groove 32 may be cooperatively configured to establish a detachable connection.

In some embodiments, the storage compartment 400 may be a drawer-type structure with the second opening 401 at the top. Since the portable refrigerator may be typically used outdoors, there will be a demand for storing items. During use, the user can store miscellaneous items such as a charger or a data cable of the portable refrigerator in the storage compartment 400, thereby improving the practicality of the portable refrigerator.

In some embodiments, the side wall of the storage compartment 400 may be designed the same as the side wall of the battery pack, so that both the storage compartment 400 and the battery pack may cooperate with the accommodating groove 30 to realize replacement.

During use, according to the operational requirements, the user may install one battery pack in each of the first accommodating groove 31 and the second accommodating groove 32, or install one battery pack in the first accommodating groove 31 and one storage compartment 400 in the second accommodating groove 32 to meet the power supply and storage demands simultaneously. Since both the battery pack and the storage compartment 400 may be detachably connected to the accommodating groove 30, the replacement between two use states may be very convenient, and the portable refrigerator may meet various application requirements.

Further, in order to enhance the practicality of the storage compartment 400, a partition or a storage grid may be provided inside the storage compartment 400 to facilitate the user to better classify and store items. In addition, a transparent window or a label slot may be defined on an outside the storage compartment 400 to enable the user to identify and access items more conveniently.

The present disclosure may further enrich the functionality of the portable refrigerator, allowing the user to store more types of items as needed. The detachable design of the storage compartment 400 may facilitate the user to adjust the internal layout of the refrigerator at any time to adapt to the demands of different occasions.

In order to optimize the above technical solutions, in some embodiments, as shown in FIG. 2, FIG. 10, and FIG. 11, a groove wall of the first accommodating groove 31 may be provided with one of a first guide groove 302 and a first guide rib 301, and the side wall of the battery pack or the side wall of the storage compartment 400 may be provided with the other of the first guide groove 302 and the first guide rib 301. The first guide groove 302 and the first guide rib 301 may be cooperatively configured to form a snap-fit connection between the first accommodating groove and the battery pack or the storage compartment 400. In some embodiments, the groove wall of the second accommodating groove 32 may be provided with one of a second guide groove 303 and a second guide rib, and the side wall of the storage compartment 400 or the side wall of the battery pack may be provided with the other of the second guide groove 303 and the second guide rib. The second guide groove 303 and the second guide rib may be cooperatively configured to form a snap-fit connection between the second accommodating groove 32 and the storage compartment 400 or the battery pack. In some embodiments, both of the above structures may exist, that is, both the first accommodating groove 31 and the second accommodating groove 32 may be provided with one of the guide groove and the guide rib, and both the side wall of the battery pack and the side wall of the storage compartment 400 may be provided with the other of the guide groove and the guide rib.

In some embodiments, taking the depth direction of the accommodating groove 30 as an x-direction, guide grooves or guide ribs may be disposed respectively on a left and right symmetric sides with the x-direction as an axis, that is, two opposite groove walls of the accommodating groove 30. The side walls of the battery pack may be adapted to the shape of the two groove walls of the first accommodating groove 31, so that the side walls of the battery pack and the two groove walls of the first accommodating groove 31 may form the snap-fit connection. The side walls of the storage compartment 400 may be adapted to the shape of the two groove walls of the second accommodating groove 32, so that the side walls of the storage compartment 400 and the two groove walls of the second accommodating groove 32 may form the snap-fit connection.

In some embodiments, an extending direction of the guide groove or the guide rib may be parallel to a direction in which the battery pack or the storage compartment 400 slides into the accommodating groove 30, so as to improve the installation and disassembly efficiency of the battery pack or the storage compartment 400.

During use, when the user puts in or takes out the battery pack or the storage compartment 400, the guide rib may move inside the guide groove, ensuring the accuracy and stability of the battery pack and the storage compartment 400 during installation and disassembly, and reducing the user's operation difficulty.

In order to further enhance the convenience of installation, anti-slip or shock-absorbing materials may be provided on the guide groove and the guide rib to reduce friction and noise during installation. In addition, positioning marks may be provided on the guide groove and the guide rib to facilitate the user to install the battery pack and the storage compartment 400 more accurately.

As shown in FIG. 11, in order to optimize the above technical solutions, the side wall of the storage compartment 400 may be provided with a second elastic arm 402. A first end of the second elastic arm 402 may be connected to the side wall of the storage compartment 400. A second end that is a free end of the second elastic arm 402 may be provided with a first pressing protrusion. When the storage compartment 400 is accommodated inside the second accommodating groove 32, the first pressing protrusion may abut against the groove wall of the second accommodating groove 32. And/or, the side wall of the battery pack may be provided with a first elastic arm. A first end of the first elastic arm may be connected to the side wall of the battery pack. A second end that is a free end of the first elastic arm may be provided with a second pressing protrusion. When the battery pack is accommodated inside the first accommodating groove 31, the second pressing protrusion may abut against the groove wall of the first accommodating groove 31.

In some embodiments, two second elastic arms 402 may be relatively disposed on the two side walls of the storage compartment 400 to realize the positioning of the storage compartment 400 in two directions. Two first elastic arms may be relatively disposed on the two side walls of the battery pack to realize the positioning of the battery pack in two directions. The second elastic arm 402 may have the same structure as the first elastic arm. Through the elasticity of the elastic arm and the abutting action of the pressing protrusion, the storage compartment 400 or the battery pack may be firmly fixed in the accommodating groove 30.

In some embodiments, the number, arrangement position, and length of the first elastic arm or the second elastic arm 402 may be adjusted according to the fastening requirements between the battery pack or the storage compartment 400 and the accommodating groove 30, thereby ensuring the stability of the battery pack or the storage compartment 400 and facilitating disassembly and replacement for the user.

During use, other connecting members may be omitted. The battery pack may be closely connected to the accommodating groove 30 only through the cooperation of the first guide groove 302 and the first guide rib 301 and the clamping between the two first elastic arms. The storage compartment 400 may be closely connected to the accommodating groove 30 only through the cooperation of the second guide groove 303 and the second guide rib and the clamping between the two second elastic arms 402. This prevents the battery pack or the storage compartment 400 from sliding freely in the accommodating groove 30, which is safe and reliable. While saving installation space, the user experience is improved.

Further, anti-slip textures or rubber pads may be provided on the pressing protrusions to improve the friction and anti-slip performance of the pressing protrusions.

In some embodiments, as shown in FIG. 1 and FIG. 2, the battery assembly 10 may include a first battery pack 11 and a second battery pack 12. The first battery pack 11 may be detachably accommodated in the first accommodating groove 31. The second battery pack 12 may be detachably accommodated in the second accommodating groove 32. That is to say, the second battery pack 12 may replace the storage compartment 400 and be accommodated in the second accommodating groove 32. Correspondingly, the second battery pack 12 may have the same structure as the storage compartment 400 required for detachable connection with the second accommodating groove 32, such as the other of the second guide groove and the second guide rib, the second elastic arm, etc., which will not be repeated here.

In some embodiments, both the first accommodating groove 31 and the second accommodating groove 32 may be configured to store the battery packs. Both the first battery pack 11 and the second battery pack 12 may be configured to directly provide electrical energy for the portable refrigerator to improve the battery life of the portable refrigerator. The portable refrigerator may include a battery power board and a pressing block. The battery power board may be connected to the first battery pack 11 and the second battery pack 12 and may be configured to obtain electrical energy from the first battery pack 11 and the second battery pack 12.

In some embodiments, as shown in FIG. 2 and FIG. 10, the groove wall of the first accommodating groove 31 may be provided with one of a first limiting protrusion 104 and a first limiting hole 304, and a side wall of the first battery pack 11 may be provided with the other of the first limiting protrusion 104 and the first limiting hole 304. The first limiting protrusion 104 and the first limiting hole 304 may be cooperatively configured to form a snap-fit connection between the first accommodating groove 31 and the first battery pack 11. And/or, the groove wall of the second accommodating groove 32 may be provided with one of a second limiting protrusion and a second limiting hole, and a side wall of the second battery pack 12 may be provided with the other of the second limiting protrusion and the second limiting hole. The second limiting protrusion and the second limiting hole may be cooperatively configured to form a snap-fit connection between the second accommodating groove 32 and the second battery pack 12.

When the first battery pack 11 is accommodated inside the first accommodating groove 31, the first limiting protrusion 104 may be snapped into the first limiting hole 304 to form a fixed connection. When the second battery pack 12 is accommodated inside the second accommodating groove 32, the second limiting protrusion may be snapped into the second limiting hole to form a fixed connection. The cooperation of the limiting protrusions and the limiting holes may be configured to assist the cooperation of the guide grooves and the guide ribs to further fix the accommodating groove 30 and the battery packs, thereby improving the structural stability of the portable refrigerator.

In some embodiments, as shown in FIG. 5 and FIG. 10, the bottom of the first accommodating groove 31 may be provided with a first foolproof boss 305, and the first battery pack 11 may be defined with a first foolproof recess 105. When the first battery pack 11 is accommodated inside the first accommodating groove 31, the first foolproof boss 305 and the first foolproof recess 105 may be cooperatively configured to form a snap-fit connection between the first battery pack 11 and the first accommodating groove 31. And/or the bottom of the second accommodating groove 32 may be provided with a second foolproof boss, and the second battery pack 12 may be defined with a second foolproof recess. When the second battery pack 12 is accommodated inside the second accommodating groove 32, the second foolproof boss and the second foolproof recess may be cooperatively configured to form a snap-fit connection between the second battery pack 12 and the second accommodating groove 32.

In some embodiments, the portable refrigerator may include an electrical connection board. The electrical connection board may be disposed proximate to the bottom of the first accommodating groove 31 and the bottom of the second accommodating groove 32. The electrical connection board may be electrically connected to the first battery pack 11 and the second battery pack 12. In order to avoid reverse installation of the first battery pack 11, the first foolproof boss 305 may be disposed at the bottom of the first accommodating groove 31, and the first foolproof recess 105 may be defined on a side of the first battery pack 11 proximate to the bottom of the first accommodating groove 31. In order to avoid reverse installation of the second battery pack 12, the second foolproof boss may be disposed at the bottom of the second accommodating groove 32, and the second foolproof recess may be defined on a side of the second battery pack 12 proximate to the bottom of the second accommodating groove 32. A protruding direction of the foolproof boss may be parallel to the installation direction of the battery pack. Through the snap-fit engagement of the foolproof boss and the foolproof recess, the stable installation of the battery pack may be achieved.

In order to optimize the above technical solutions, as shown in FIG. 1 and FIG. 2, the refrigerator housing 50 may include a side plate 500 defined with a third opening. The first opening of the at least one accommodating groove 30 may be accessible from an exterior via the third opening in the side plate 500. The portable refrigerator may further include a DC power supply assembly 600 and/or a photovoltaic panel assembly disposed inside the refrigerator housing 50. The DC power supply assembly 600 and/or the photovoltaic panel assembly may be respectively electrically connected to the battery pack. Insertion interfaces of the DC power supply assembly 600 and/or the photovoltaic panel assembly may be respectively defined on the side plate 500 at a location below the first opening of the accommodating groove 30.

In some embodiments, the first accommodating groove 31 and the second accommodating groove 32 may be disposed in parallel. First openings of the first accommodating groove 31 and the second accommodating groove 32 may be accessible from an exterior via the third opening on the side plate 500. The DC power supply assembly 600 may include a DC power socket. The photovoltaic panel assembly may include a photovoltaic panel socket. The DC power socket and the photovoltaic panel socket may be electrically connected to the battery pack. The DC power socket and the photovoltaic panel socket may be disposed on the side plate 500 and below the first opening of the accommodating groove 30.

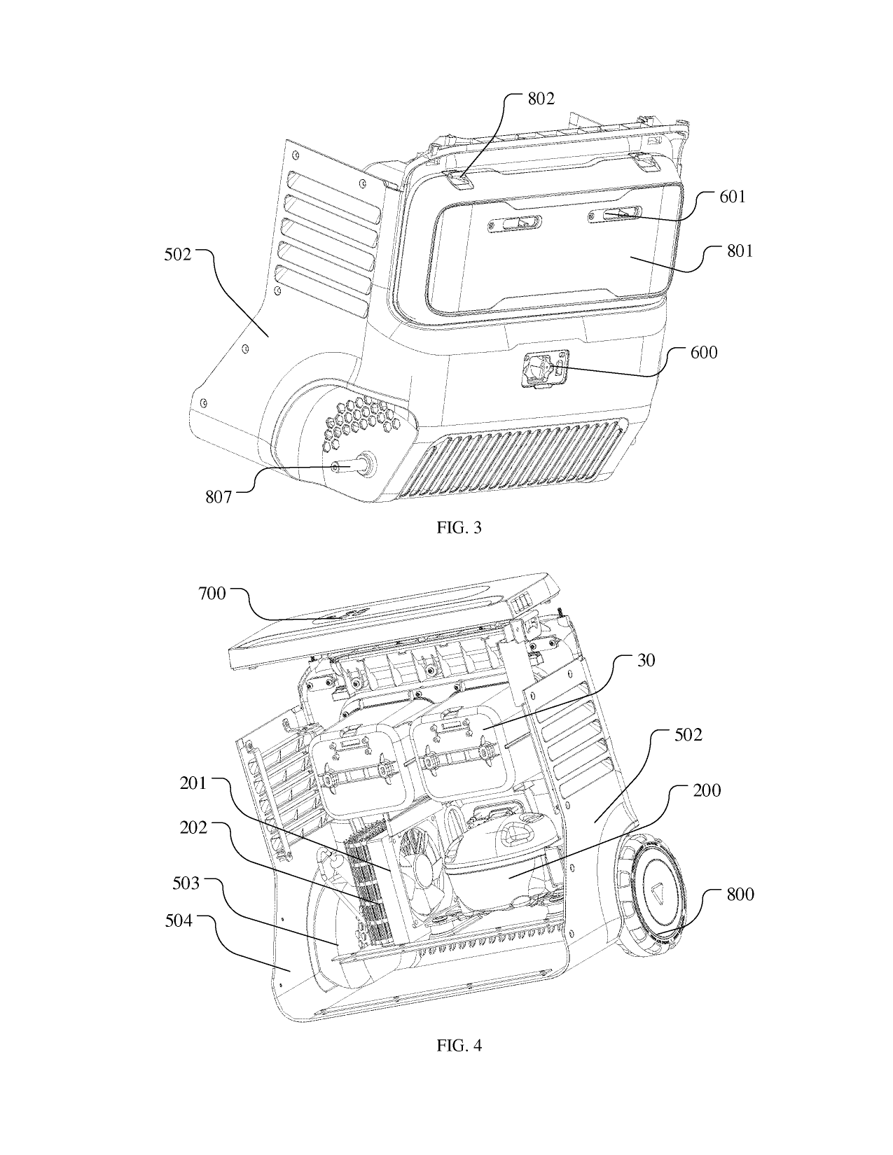

In order to optimize the above technical solutions, as shown in FIG. 3, the battery assembly 10 may further include an output interface 601. The output interface 601 may be disposed on an outer side of the battery pack facing the side plate 500 and may be electrically connected to the battery pack. The output interface 601 may include at least one of an universal serial bus interface, a DC interface, and an AC interface.

In some embodiments, the battery pack may include a connection end. The connection end may be directly connected to an electrical device of the refrigerator, so as to supply power to the refrigerator. The DC power supply assembly 600 and/or the photovoltaic panel assembly may provide additional electrical energy input interfaces, increasing the ways for the portable refrigerator to obtain electrical energy. The output interface 601 may output electrical energy for the user.

The present disclosure may achieve the stable supply and flexible management of electrical energy through the modular design of the DC power supply assembly 600 and/or the photovoltaic panel assembly and the output interface 601. The arrangement of multiple power supply parts may improve the compatibility and scalability of the product.

Further, according to the use requirements, a temperature sensor and a battery management system (BMS) may be provided in the battery pack, so as to real-time monitor the temperature and status of the battery pack and optimize a charging and discharging process. In addition, wireless charging function may be provided to improve the convenience and usability of the product.

In some embodiments, the DC power socket and the photovoltaic panel socket may be configured to provide additional electrical energy input manners (e.g., connecting to a DC power supply via the DC power socket or providing solar charging via the photovoltaic socket) other than the battery pack.

In some embodiments, the output interface 601 may include but is not limited to a USB interface, a TYPE-C interface, etc., and may be configured to provide charging and discharging functions to meet the user's power demands when the portable refrigerator is used outdoors.

During use, when the DC power supply assembly 600 and/or the photovoltaic panel assembly are in power supply states, the DC power supply assembly 600 and/or the photovoltaic panel assembly may directly supply power to the refrigerator to maintain the operation of the refrigerator or may charge the battery pack. When the DC power supply assembly 600 and/or the photovoltaic panel assembly charge the battery pack, the battery pack may supply power to electronic devices via the output interface 601. When the DC power supply assembly 600 and/or the photovoltaic panel assembly are in non-power supply states, the battery pack may directly supply power to the refrigerator and may also supply power to the electronic devices via the output interface 601 simultaneously. When the battery pack needs to be taken out to function as a mobile power supply, the battery pack may be taken out of the accommodating groove 30 to supply power to the electronic devices anytime and anywhere. When the battery pack is out of power, the battery pack may be taken out from the accommodating groove 30 for external charging.

This design may improve the power supply diversity and charging convenience of the refrigerator, enabling the user to choose different power supply manners to supply power to the refrigerator according to requirements. The arrangement of the output interface 601 may facilitate the user to charge other devices, improving the practicality and convenience of the refrigerator.

In order to optimize the above technical solutions, as shown in FIG. 1 and FIG. 10, the battery assembly 10 may further include a rotating cover 602. An end of the rotating cover 602 may be rotatably connected to the battery pack, and the other end may be detachably connected to the battery pack.

In some embodiments, the rotating cover 602 may be made of silicone material. A slot configured to accommodate the rotating cover 602 may be defined on an outer surface of the battery pack. When the rotating cover 602 is buckled in the slot, the outer surface of the battery pack may be designed smoothly. The rotating cover 602 may block the output interface 601, and the output interface 601 may be in a closed state to prevent water or sand from entering the output interface 601 when the portable refrigerator is used outdoors. When the end of the rotating cover 602 is connected to the battery pack and the other end is separated from the slot, the output interface 601 may be in an open state and may be configured for charging.

During use, when the output interface 601 needs to be used to charge electronic devices, there is no need to take the battery pack out of the accommodating groove 30. The output interface 601 may be exposed simply by rotating the rotating cover 602, enabling the user to enjoy the charging experience quickly and conveniently. After charging is completed, the rotating cover 602 may be rotated again to close the output interface 601, thereby preventing dust from entering the output interface 601, protecting the battery pack, and realizing the waterproof and dustproof protection of the output interface 601.

This design may improve the durability and safety of the output interface 601 and extend the service life of the refrigerator. Meanwhile, the design of the rotating cover 602 may facilitate the user to quickly expose and close the output interface 601, improving the convenience of use.

In order to further enhance the waterproof and dustproof effect, a sealing ring or waterproof glue may be provided at a connection between the rotating cover 602 and the slot of the battery pack. In addition, anti-slip textures or buttons may be provided on the rotating cover 602 to facilitate the user to expose and close the rotating cover 602 more easily.

In some embodiments, when the battery assembly 10 includes the first battery pack 11 and the second battery pack 12, the battery assembly 10 may further include a first output interface and a first rotating cover corresponding to the first battery pack 11. The first output interface may be disposed on an outer side of the first battery pack 11 facing the side plate 500 and may be electrically connected to the first battery pack 11. An end of the first rotating cover may be rotatably connected to the first battery pack 11, and the other end of the first rotating cover may be snap-connected to the first battery pack 11. And/or, the battery assembly 10 may further include a second output interface and a second rotating cover corresponding to the second battery pack 12. The second output interface may be disposed on an outer side of the second battery pack 12 facing the side plate 500 and may be electrically connected to the second battery pack 12. An end of the second rotating cover may be rotatably connected to the second battery pack 12, and the other end of the second rotating cover may be snap-connected to the second battery pack 12.

In order to optimize the above technical solutions, as shown in FIG. 1, the portable refrigerator may further include a display screen 700. The refrigerator housing 50 may include a top cover 501. An end of the top cover 501 may be vertically connected to the top of the side plate 500. The display screen 700 may be fixed on the top cover 501 and located above the battery pack. The display screen 700 may be electrically connected to the battery pack.

In order to optimize the above technical solutions, the portable refrigerator may further include a moving assembly. The moving assembly may be fixed at the bottom of the portable refrigerator and proximate to the refrigeration assembly, and may be configured to drive the portable refrigerator to move, improving the portability of the refrigerator.

In some embodiments, in the space on one side of the refrigerator, the assembly installation area may be disposed with the display screen 700, the battery pack, the refrigeration assembly, and the moving assembly from top to bottom, thereby realizing the rational use of the internal space of the refrigerator. Since the other side of the refrigerator is the refrigeration area, the maximization of the refrigeration area may be realized, and the space utilization rate of the refrigerator may be improved.

In some embodiments, the display screen 700 may be configured to display information such as the operating status and temperature of the refrigerator. The moving assembly may be configured to drive the refrigerator to move, facilitating the user to use the refrigerator in different occasions.

In some embodiments, when the refrigerator is powered on, all of the compressor 200, the radiator 201, the condenser 202, and the display screen 700 may need electricity. These electrical components may be distributed in the assembly installation area of the refrigerator. The display screen 700 may be disposed above the battery pack, and the compressor 200, the radiator 201, and the condenser 202 may be disposed below the battery pack. While facilitating power supply, the structural design of the assembly installation area of the refrigerator may better, more fully, and more reasonably utilize the internal space of the refrigerator.

In some embodiments, as shown in FIG. 1 and FIG. 2, the moving assembly may include a moving wheel 800 and a support shaft 807. Two ends of the support shaft 807 may be respectively connected to one moving wheel 800. The moving assembly may be configured to drive the portable refrigerator to move via two moving wheels 800. As shown in FIG. 1 to FIG. 4, the refrigerator housing 50 may include a first side surface 502 and a second side surface 504 disposed oppositely. A side of the first side surface 502 may be connected to the top cover 501, and the other side of the first side surface 502 may be connected to the side plate 500. A side of the second side surface 504 may be connected to the top cover 501, and the other side of the second side surface 504 may be connected to the side plate 500. The two ends of the support shaft 807 may be respectively rotatably connected to the first side surface 502 and the second side surface 504. Each of the first side surface 502 and the second side surface 504 may be defined with a protruding accommodating slot 503. The protruding accommodating slot 503 may protrude from the outside of the refrigerator housing 50 to the inside of the refrigerator housing 50. The protruding accommodating slot 503 may be configured to accommodate the moving wheel 800.

In some embodiments, the protruding accommodating slot 503 may be correspondingly disposed below the refrigeration assembly to prevent steps or protrusions in the refrigeration area, ensuring that the refrigeration area has a vertical inner wall from top to bottom.

The present disclosure may further integrate the display screen 700 and the moving assembly into the assembly installation area, thereby making full use of the space of the assembly installation area of the refrigerator and improving the space utilization rate of the refrigerator.

As shown in FIG. 10 and FIG. 11, in order to optimize the above technical solutions, the battery pack may include a handle 101. The battery pack may include a first side wall 103 and a second side wall disposed oppositely. Two ends of the handle 101 may be respectively rotatably connected to the first side wall 103 and the second side wall. A middle portion of the handle 101 may be disposed with a first handle position 102. And/or the storage compartment 400 may include a second handle position 403. The second handle position 403 may be disposed at the top of the storage compartment 400. And/or the storage compartment 400 may include an indentation 404. The indentation 404 may be defined on the side wall of the storage compartment 400. The first handle position 102, the second handle position 403, and the indentation 404 may be configured for the user to hold.

In some embodiments, the first handle position 102 may be designed to protrude from the handle 101, so that the user can easily hold the handle 101. Since the top of the storage compartment 400 is defined with the second opening 401, the second handle position 403 may be disposed at the top of an end surface of the storage compartment 400 away from the side plate 500 and may be designed to protrude from the top of the end surface.

In some embodiments, the indentation 404 may be defined on two opposite side walls connected to the end surface of the storage compartment 400 away from the side plate 500. The indentation 404 may also be defined at the bottom of the end surface of the storage compartment 400 away from the side plate 500. The indentation 404 may further be defined at the two opposite side walls and the bottom of the end surface simultaneously. During use, the user may put his/her hand in and hold the indentation 404. The arrangement position and shape of the indentation 404 should be designed to facilitate the user in gripping the storage compartment 400 from various angles.

In some embodiments, when the battery pack is installed in the accommodating groove 30, the handle 101 may be accommodated proximate to the outer surface of the battery pack.

This design may simplify the process of the user installing and removing the storage compartment 400 or the battery pack, reducing the operation difficulty. Meanwhile, the design of the handle 101 and the handle position may also improve the practicality and convenience of the storage compartment 400 or the battery pack, facilitating the user to push and pull the storage compartment 400 in the second accommodating groove 32 and the battery pack in the first accommodating groove 31 with various gestures, facilitating the storage and removal of the storage compartment 400 and the battery pack from the accommodating groove 30, and improving the user experience.

In order to further enhance portability and usability, anti-slip textures or rubber pads may be disposed on the handle 101 and the handle position to improve grip and comfort.

As shown in FIG. 3, in order to optimize the above technical solutions, the portable refrigerator may further include a battery cover 801 defined with a slot. The battery cover 801 may be detachably or rotatably covered on the third opening of the side plate 500. After the battery cover 801 is covered on the side plate 500, the rotating cover 602 may extend outward through the slot or be at least partially accommodated in the slot.

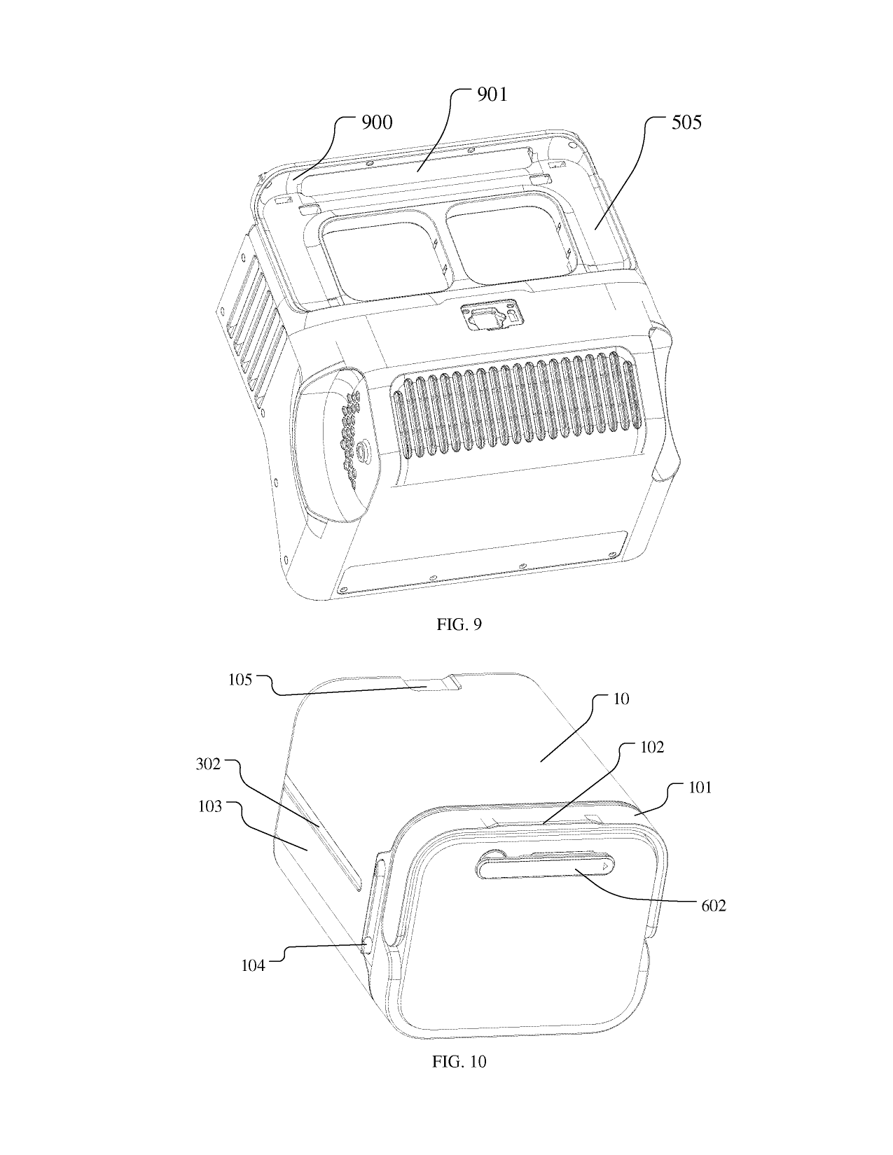

In order to optimize the above technical solutions, as shown in FIG. 1 and FIG. 9, the side plate 500 may further be defined with an inner concave part 505 recessed toward an inside of the refrigerator housing 50. At least one accommodating groove 30 may be defined in the inner concave part 505. When the battery pack is disposed inside the accommodating groove 30, an end of the battery pack away from the refrigerator housing 50 may protrude from the inner concave part 505. The inner concave part 505 may be a structural form of the third opening of the side plate 500.

In some embodiments, the battery cover 801 and the inner concave part 505 may be detachably connected via a plug-fit connection, a snap-fit connection, etc. The battery cover 801 and the inner concave part 505 may be rotatably connected via a rotating shaft, etc.

In some embodiments, when the battery pack is disposed inside the first accommodating groove 31 and the storage compartment 400 is disposed inside the second accommodating groove 32, ends of the battery pack and the storage compartment 400 away from the refrigerator housing 50 may protrude from the inner concave part 505. However, along the vertical direction, i.e., when viewed from top to bottom, the ends of the battery pack and the storage compartment 400 away from the refrigerator housing 50 may be flush with a portion of the side plate 500 excluding the inner concave part 505, forming a coplanar alignment along a straight line. Alternatively, the inner concave part 505 may hide the ends of the battery pack and the storage compartment 400 away from the refrigerator housing 50, preventing the battery pack and the storage compartment 400 from protruding from the side plate 500, thereby protecting the battery pack and the storage compartment 400.

In some embodiments, after installing the battery pack and the storage compartment 400 in the first accommodating groove 31 and the second accommodating groove 32 respectively, the battery cover 801 may be connected to the side plate 500 to further protect the battery pack and the storage compartment 400. Meanwhile, the battery cover 801 may close the inner concave part 505, further ensuring the installation stability of the battery pack, avoiding dust or moisture from entering the accommodating groove 30, and improving the hygiene performance and esthetics of the refrigerator.

In order to further enhance the installation stability and dustproof and waterproof effect of the battery pack, a sealing ring or waterproof glue may be provided at a connection between the battery cover 801 and the side plate 500. In addition, a lock or a buckle may be provided on the battery cover 801 to facilitate the user to fix the battery cover 801 more firmly.

It should be noted that, as shown in FIG. 1 to FIG. 3, the top of the battery cover 801 may be provided with a buckle 802, and the side plate 500 may be defined with a buckle hole 803. The buckle 802 may be an elastic buckle. During use, the buckle 802 may be installed inside the buckle hole 803. The top of the buckle 802 may be snapped at an edge of the buckle hole 803. When the battery cover 801 needs to be disassembled, the buckle 802 may be pressed along the vertical direction to be deformed, and the top of the buckle 802 may be no longer snapped at the edge of the buckle hole 803, enabling the battery cover 801 to be detached.

Further, the bottom of the battery cover 801 may be provided with an insertion block. A corresponding position of the side plate 500 may be defined with an insertion hole 804 that may be inserted and connected with the insertion block. The insertion block and the insertion hole 804 may be inserted along the vertical direction to form a fixation for the bottom of the battery cover 801.

Further, as shown in FIG. 2 and FIG. 7, the battery cover 801 may further include a connecting strip 805. The bottom of the battery cover 801 may be defined with a first mounting hole. The side plate 500 may further be defined with a second mounting hole 806. An end of the connecting strip 805 may be snapped with the first mounting hole, and the other end of the connecting strip 805 may be snapped with the second mounting hole 806.

In some embodiments, the connecting strip 805 may be made of elastic material, including but not limited to silicone, rubber, etc.

During use, the connecting strip 805 may be connected to the battery cover 801 and the side plate 500 respectively. When installing the battery cover 801, the insertion block may be inserted into the insertion hole 804, and the buckle 802 may be buckled with the buckle hole 803, so as to form the fixation of the battery cover 801 and the side plate 500. When the battery pack or the storage compartment 400 needs to be disassembled, the buckle 802 may be pressed, and the top of the battery cover 801 may be separated from the side plate 500. However, under the action of the connecting strip 805, the bottom of the battery cover 801 may not be separated from the side plate 500. After the disassembly is completed, the battery cover 801 and the side plate 500 may be connected again.

Such arrangement may enable the battery cover 801 to be firmly installed on the side plate 500, not easy to lose, and ensure the stability and safety of the battery pack or the storage compartment 400.

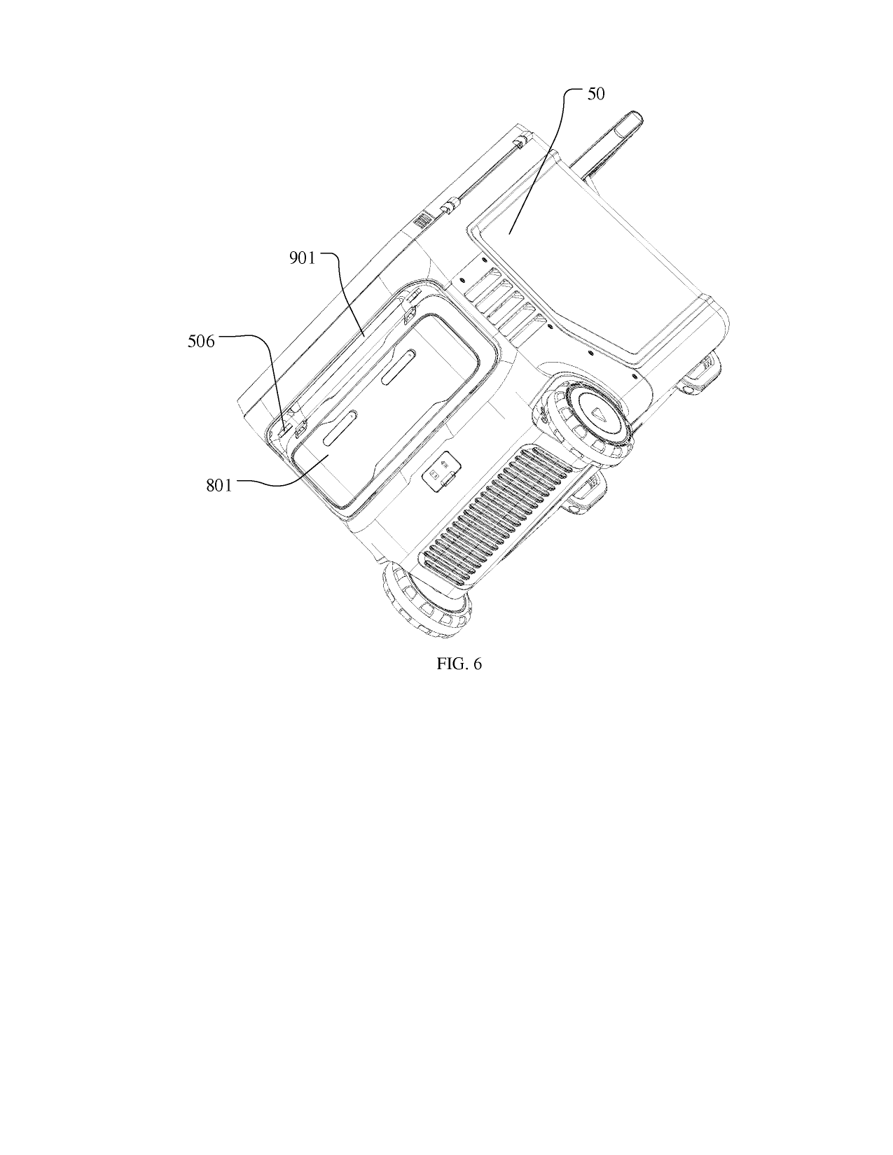

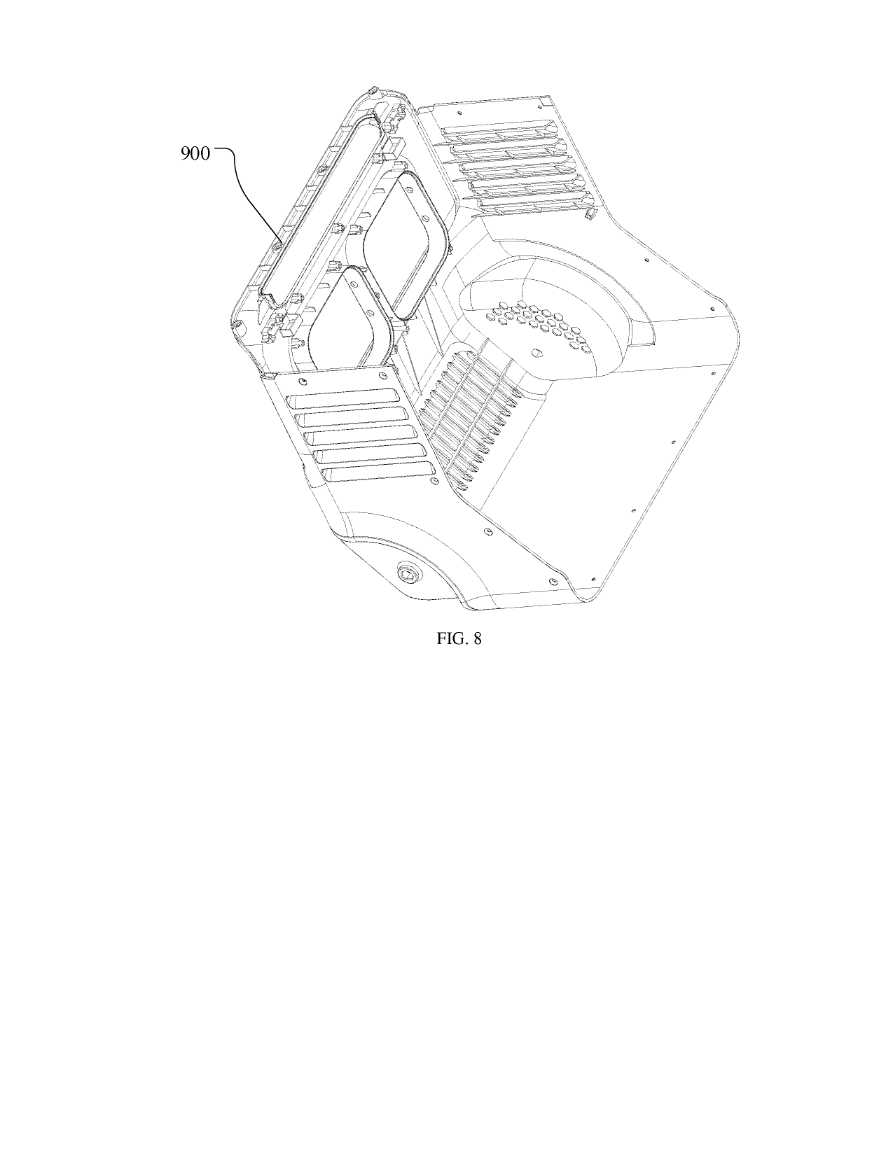

In some embodiments, as shown in FIG. 6, FIG. 8, and FIG. 9, the top of the side plate 500 may be provided with a grip 900 configured to hold and lift the refrigerator. The grip 900 may be disposed on the side plate 500 of the refrigerator housing 50. A grip hole 901 configured to hold may be defined between the grip 900 and the side plate 500 of the refrigerator housing 50. The top cover 501 of the refrigerator housing 50 may cover at least an area above the grip 900, thereby shielding the grip hole 901 from the top of the refrigerator housing 50.

The top cover 501 may only cover above the grip 900, or be integrated with another cover plate covering above the refrigeration area in the refrigerator housing 50, as long as the cover plate may open and close the refrigeration area.

The inner concave part 505 may be disposed adjacent to the grip 900 and below the grip hole 901. A bottom wall surface of the side plate 500 of the refrigerator housing 50 located below the inner concave part 505 may be flush with an outer side surface of the grip 900. Alternatively, a vertical interval between the bottom wall surface of the side plate 500 and the outer side surface of the grip 900 may be less than or equal to 5 centimeters. The grip 900 and the inner concave part 505 may be cooperatively configured to cover the grip hole 901 from a side surface of the refrigerator housing 50.

It should be noted that the bottom wall surface of the side plate 500 of the refrigerator housing 50 located below the inner concave part 505 being flush with the outer side surface of the grip 900 may mean that a surface of the grip 900 located outside the refrigerator housing 50 is on the same plane as a surface where the bottom wall surface below the inner concave part 505 is located. The vertical interval between the bottom wall surface of the side plate 500 of the refrigerator housing 50 located below the inner concave part 505 and the outer side surface of the grip 900 being less than or equal to 5 centimeters may mean that a vertical distance between a plane where the surface of the grip 900 located outside the refrigerator housing 50 is located and a plane where the bottom wall surface below the inner concave part 505 is located is less than or equal to 5 centimeters. For example, the grip 900 may be recessed into the refrigerator housing 50 by less than or equal to 5 centimeters. Alternatively, the grip 900 may be protruded out of the refrigerator housing 50 by less than or equal to 5 centimeters.

In some embodiments, the grip hole 901 may be generally defined along the vertical direction, so that the user's hand can extend into the grip hole 901 from the bottom of the grip 900 along the horizontal direction and hold the grip 900, thereby facilitating the user to move the portable refrigerator.

The portable refrigerator provided by the embodiments of the present disclosure may be disposed with the grip 900 on the side plate 500 of the refrigerator housing 50. The grip 900 and the side plate 500 may together form the grip hole 901. The grip hole 901 may be fully covered by the top cover 501 and the inner concave part 505, resulting in a concealed design for the grip 900 on the front of the portable refrigerator. In this way, the grip 900 may be more compactly integrated into the portable refrigerator, achieving the purpose of reducing the space occupied by the grip 900 and improving the esthetics of the refrigerator.

In some embodiments, a vertical distance from the bottom of the grip 900 to an upper side surface of the battery pack may range from 25 millimeters to 45 millimeters. And/or, a vertical distance from the bottom of the grip 900 to an upper side surface of the storage compartment 400 may range from 25 millimeters to 45 millimeters.

In some embodiments, when the grip 900 is designed to be inclined, the vertical distance from the bottom of the grip 900 to the upper side surface of the battery pack may be different from the vertical distance from the bottom of the grip 900 to the upper side surface of the storage compartment 400. When the grip 900 is designed to be horizontal, the vertical distance from the bottom of the grip 900 to the upper side surface of the battery pack may be the same as the vertical distance from the bottom of the grip 900 to the upper side surface of the storage compartment 400. The vertical distance from the bottom of the grip 900 to the upper side surface of the battery pack or the upper side surface of the storage compartment 400 may be changed according to structural demands to facilitate the user to grip.

When the battery cover 801 is connected to the inner concave part 505, the battery cover 801 may be flush with the side of the grip 900 away from the refrigerator housing 50.

Further, as shown in FIG. 1, an edge of the top cover 501 may be integrated with a rotating member 5011. The rotating member 5011 may be rotatably connected to the edge of the top cover 501. During use, the user may open or close the refrigeration area by toggling the rotating member 5011.

Further, the first side surface 502 or the second side surface 504 may be integrated with a bottle opener 5012. An edge of a main body part of the bottle opener 5012 may be rotatably connected to the first side surface 502 or the second side surface 504. When a bottle needs to be opened, the main body of the bottle opener 5012 may be rotated out to form a certain angle with the first side surface 502 or the second side surface 504, thereby facilitating a bottle-opening operation. When bottle-opening is not required, the main body of the bottle opener 5012 may be folded against and stored on the first side surface 502 or the second side surface 504.

In some embodiments, as shown in FIG. 6 and FIG. 12, the portable refrigerator may further include a hook 506. The hook 506 may be fixedly connected to the inner concave part 505. The hook 506 may be disposed below the grip hole 901.

In some embodiments, the hook 506 may be configured to fix the portable refrigerator at a certain position, or to hang items such as shopping bags and backpacks on the portable refrigerator, thereby improving the practicality and convenience of the portable refrigerator.

In some embodiments, the number of the hooks 506 may be more than two. The hook 506 may be of a foldable design, enabling the hook 506 to be stored when not in use to reduce space occupation.

The hook 506 may be integrated into the inner concave part 505, which not only saves space and enhances the overall esthetics and usability of the portable refrigerator, but also helps improve the overall load-bearing capacity of the portable refrigerator.

It should be noted that the portable refrigerator provided by the embodiments of the present disclosure may be applied in the technical field of outdoor refrigerator device or other technical fields. Other technical fields may refer to any field except the technical field of outdoor refrigerator device. The above embodiments may only be examples and may not limit the application field of the portable refrigerator provided by the present disclosure.

It should be understood that the terms used in the description may be only for the purpose of describing exemplary embodiments and may not be intended to be limiting. Unless explicitly indicated otherwise in the description, singular forms such as "a", "an", and "the" as used in the description may also include plural forms. The terms "including", "comprising", "disposed with", and "defined with" may be inclusive and thus indicate the presence of the recited features, steps, operations, elements, and/or components, but do not exclude the presence or addition of one or more other features, steps, operations, elements, components, and/or combinations thereof. The method operations, processes, and acts described in the description may not be construed as requiring execution in a specific order described or illustrated, unless a specific execution order is explicitly indicated. It should also be understood that alternative operations may be employed.

Although the terms "first", "second", "third", etc. may be used in the description to refer to multiple elements, components, areas, layers, and/or sections, these elements, components, areas, layers, and/or sections should not be limited by these terms. These terms may only be used to distinguish one element, component, area, layer, or section from another element, component, area, layer, or section. Unless explicitly indicated otherwise in the description, the terms such as "first" and "second" and other numerical terms may not imply an order or sequence when used in the description. Therefore, a first element, first component, first area, first layer, or first section discussed above may be referred to as a second element, second component, second area, second layer, or second section without departing from the teachings of the exemplary embodiments.

The above embodiments may only be implementations of the present disclosure, enabling those skilled in the art to understand or practice the present disclosure. Various modifications to the embodiments may be obvious to those skilled in the art. The general principles defined herein may be implemented in other embodiments without departing from the spirit or scope of the present disclosure. Therefore, the present disclosure may not be limited to the embodiments shown herein but shall conform to the broadest scope consistent with the principles and novel features claimed herein.

1. A portable refrigerator, comprising a refrigerator housing, wherein
an interior of the refrigerator housing is defined with a refrigeration area and an assembly installation area disposed side by side and adjacent to each other;
a battery assembly and a refrigeration assembly are disposed in the assembly installation area, the refrigeration assembly is disposed at a bottom of a side of the refrigerator housing, and the battery assembly is disposed above the refrigeration assembly;
the refrigeration area is defined by inner liner walls configured to accommodate and refrigerate items, and a side of the inner liner walls proximate to the assembly installation area has no overlap in a vertical direction with sides of the refrigeration assembly and the battery assembly proximate to the refrigeration area.

2. The portable refrigerator according to claim 1, wherein the refrigerator housing comprises at least one accommodating groove, the battery assembly comprises at least one battery pack, the at least one accommodating groove is configured to accommodate the at least one battery pack, a first opening of each of the at least one accommodating groove is accessible from an exterior of the refrigerator housing, and a side wall of each of the at least one battery pack and a groove wall of a corresponding accommodating groove are cooperatively configured to establish a detachable connection.

3. The portable refrigerator according to claim 2, wherein the at least one accommodating groove comprises a first accommodating groove and a second accommodating groove disposed side by side;
the portable refrigerator further comprises a storage compartment, and the storage compartment comprises a compartment body with a second opening at the top;
the first accommodating groove is configured to alternatively accommodate one of the at least one battery pack or the storage compartment, and the second accommodating groove is configured to alternatively accommodate the storage compartment or one of the at least one battery pack;
a side wall of the storage compartment and a groove wall of the first accommodating groove and/or a groove wall of the second accommodating groove are cooperatively configured to establish a detachable connection, and a side wall of the one of the at least one battery pack and the groove wall of the first accommodating groove and/or the groove wall of the second accommodating groove are cooperatively configured to establish a detachable connection.

4. The portable refrigerator according to claim 3, wherein
the groove wall of the first accommodating groove is provided with one of a first guide groove and a first guide rib, the side wall of the one of the at least one battery pack or the side wall of the storage compartment is provided with the other one of the first guide groove and the first guide rib, and the first guide groove and the first guide rib are cooperatively configured to form a snap-fit connection between the first accommodating groove and the one of the at least one battery pack or the storage compartment;
and/or, the groove wall of the second accommodating groove is provided with one of a second guide groove and a second guide rib, the side wall of the storage compartment or the side wall of the one of the at least one battery pack is provided with the other one of the second guide groove and the second guide rib, and the second guide groove and the second guide rib are cooperatively configured to form a snap-fit connection between the second accommodating groove and the storage compartment or the one of the at least one battery pack.

5. The portable refrigerator according to claim 3, wherein the side wall of the one of the at least one battery pack is provided with a first elastic arm, a first end of the first elastic arm is connected to the side wall of the one of the at least one battery pack, a second end that is a free end of the first elastic arm is provided with a second pressing protrusion; wherein, when the one of the at least one battery pack is accommodated inside the first accommodating groove, the second pressing protrusion abuts against the groove wall of the first accommodating groove;
and/or, the side wall of the storage compartment is provided with a second elastic arm, a first end of the second elastic arm is connected to the side wall of the storage compartment, a second end that is a free end of the second elastic arm is provided with a first pressing protrusion; wherein, when the storage compartment is accommodated inside the second accommodating groove, the first pressing protrusion abuts against the groove wall of the second accommodating groove.

6. The portable refrigerator according to claim 2, wherein the at least one accommodating groove comprises a first accommodating groove and a second accommodating groove arranged side by side, and the battery assembly comprises a first battery pack detachably accommodated in the first accommodating groove and a second battery pack detachably accommodated in the second accommodating groove;
a groove wall of the first accommodating groove is provided with one of a first limiting protrusion and a first limiting hole, a side wall of the first battery pack is provided with the other one of the first limiting protrusion and the first limiting hole, and the first limiting protrusion and the first limiting hole are cooperatively configured to form a snap-fit connection between the first accommodating groove and the first battery pack;
and/or, a groove wall of the second accommodating groove is provided with one of a second limiting protrusion and a second limiting hole, a side wall of the second battery pack is provided with the other one of the second limiting protrusion and the second limiting hole, and the second limiting protrusion and the second limiting hole are cooperatively configured to form a snap-fit connection between the second accommodating groove and the second battery pack.

7. The portable refrigerator according to claim 2, wherein the at least one accommodating groove comprises a first accommodating groove and a second accommodating groove arranged side by side, and the battery assembly comprises a first battery pack detachably accommodated in the first accommodating groove and a second battery pack detachably accommodated in the second accommodating groove;
a bottom of the first accommodating groove is provided with a first foolproof boss, and the first battery pack is defined with a first foolproof recess; wherein when the first battery pack is accommodated inside the first accommodating groove, the first foolproof boss and the first foolproof recess are cooperatively configured to form a snap-fit connection between the first accommodating groove and the first battery pack;
and/or, a bottom of the second accommodating groove is provided with a second foolproof boss, and the second battery pack is defined with a second foolproof recess; wherein when the second battery pack is accommodated inside the second accommodating groove, the second foolproof boss and the second foolproof recess are cooperatively configured to form a snap-fit connection between the second accommodating groove and the second battery pack.

8. The portable refrigerator according to claim 2, wherein the refrigerator housing comprises a side plate defined with a third opening, and the first opening of each of the at least one accommodating groove is accessible from an exterior through the third opening in the side plate;
the portable refrigerator further comprises a DC power supply assembly and/or a photovoltaic panel assembly disposed inside the refrigerator housing, the DC power supply assembly and/or the photovoltaic panel assembly are electrically connected to the at least one battery pack, and insertion interfaces of the DC power supply assembly and/or the photovoltaic panel assembly are defined on the side plate at a location below the first opening of each of the at least one accommodating groove.

9. The portable refrigerator according to claim 8, wherein the battery assembly further comprises an output interface and a rotating cover corresponding to each of the at least one battery pack, and the output interface is disposed on an outer side of a corresponding one of the at least one battery pack facing the side plate and is electrically connected to the corresponding one of the at least one battery pack; and
an end of the rotating cover is rotatably connected to a corresponding one of the at least one battery pack, and the other end of the rotating cover is detachably connected to the corresponding one of the at least one battery pack.

10. The portable refrigerator according to claim 9, wherein the output interface comprises at least one of an universal serial bus interface, a DC interface, and an AC interface.

11. The portable refrigerator according to claim 8, wherein the portable refrigerator further comprises a display screen, and the refrigerator housing further comprises a top cover;
an end of the top cover is connected to the top of the side plate, the display screen is fixed on the top cover and located above the at least one battery pack, and the display screen is electrically connected to the at least one battery pack.

12. The portable refrigerator according to claim 9, wherein the portable refrigerator further comprises a battery cover defined with a slot, and the battery cover is configured to be detachably or rotatably covered on the third opening of the side plate; wherein when the battery cover is covered on the side plate, the rotating cover protrudes outward through the slot or is at least partially accommodated in the slot.

13. The portable refrigerator according to claim 1, wherein the refrigeration assembly comprises a compressor, a radiator, and a condenser, and the compressor, the radiator, and the condenser are disposed side by side below the battery assembly.

14. The portable refrigerator according to claim 13, wherein the radiator comprises a fan and a blocking member, and the compressor, the fan, and the condenser are disposed side by side inside the refrigerator housing and define a heat dissipation air duct; the blocking member is connected to both a shell of the fan and an inner housing wall of the refrigerator housing that defines the heat dissipation air duct, thereby forming a single-channel air duct between the compressor and the condenser.

15. The portable refrigerator according to claim 1, wherein the portable refrigerator further comprises a moving assembly, and the moving assembly is fixed at a bottom of the portable refrigerator and proximate to the refrigeration assembly, and is configured to drive the portable refrigerator to move.

16. The portable refrigerator according to claim 15, wherein the moving assembly comprises two moving wheels and a support shaft, two ends of the support shaft are respectively connected to the two moving wheels, and the moving assembly is configured to drive the portable refrigerator to move via the two moving wheels.

17. The portable refrigerator according to claim 2, wherein the portable refrigerator further comprises a grip, the grip is disposed on the side plate of the refrigerator housing, and a grip hole configured to be held is defined between the grip and the side plate of the refrigerator housing;
the top cover of the refrigerator housing covers at least an area above the grip to shield the grip hole from the top of the refrigerator housing.

18. The portable refrigerator according to claim 17, wherein the side plate of the refrigerator housing is further defined with an inner concave part recessed toward an inside of the refrigerator housing, the inner concave part is disposed adjacent to the grip and located below the grip hole, and the at least one accommodating groove is defined in the inner concave part;
a bottom wall surface of the side plate of the refrigerator housing located below the inner concave part is flush with an outer side surface of the grip, or a vertical interval between the bottom wall surface of the side plate and the outer side surface of the grip is less than or equal to 5 centimeters;
the grip and the inner concave part are cooperatively configured to cover the grip hole from a side surface of the refrigerator housing.

19. The portable refrigerator according to claim 18, wherein a value of a vertical distance from a bottom of the grip to an upper side surface of the at least one battery pack ranges from 25 millimeters to 45 millimeters.

20. The portable refrigerator according to claim 18, wherein the portable refrigerator further comprises a hook, the hook is fixedly connected to the inner concave part, and the hook is disposed below the grip hole.
